(19) United States
(12) Patent Application Publication
(10) Pub. No.: US 2010/0053258 A1
(43) Pub. Date: Mar. 4, 2010

(54) LIQUID TRANSPORTING METHOD AND METHOD OF CLEANING LIQUID EJECTING APPARATUS

(75) Inventors: Takeo SEINO, Shiojiri-shi (JP); Masaki UCHIYAMA, Azumino-shi (JP); Hideya YOKOUCHI, Okaya-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/552,408

(22) Filed: Sep. 2, 2009

(30) Foreign Application Priority Data
Sep. 2, 2008 (JP) 2008-224339

(51) Int. Cl. B41J 2/165

(52) U.S. Cl. 347/30

(57) ABSTRACT

Provided is a liquid transporting method in a liquid ejecting apparatus having a fluid ejecting head having a nozzle, a liquid storing unit connected through a flow passage to the fluid ejecting head, and a suction unit sucking an inner portion of the nozzle from a nozzle opening side, wherein a portion of the flow passage is used as a pump chamber, and a pump driven to change an internal volume of the pump chamber and an output valve opened only at the time when the output valve is pressed from the pump are provided, the liquid transporting method including: performing choke suction of charging the pump with the liquid, and performing a suction operation of sucking the inner portion of the nozzle by using the suction unit, and then, performing a transmission operation of pressing the liquid from the pump to the output valve.

This application claims the benefit of Japanese Patent Application No. 2008-224339, filed Sep. 2, 2008, which is expressly incorporated herein by reference in its entirety.

### BACKGROUND

1. Technical Field

The present invention relates to a liquid transporting method and a method of cleaning the liquid ejecting apparatus.

2. Related Art

As a liquid ejecting apparatus, a printer (liquid ejecting apparatus), in which a pump is disposed in a flow passage between an ink tank (liquid storing unit) and an ink jet head (liquid ejecting head), is disclosed in JP-A-5-185603. In addition, check valves that allow an ink (liquid) to flow from ink tank to ink jet head are disposed upstream and downstream of the pump. In the printer, the pump in the flow passage transmits ink towards ink jet head.

In addition, an ink jet printer (liquid ejecting apparatus), in which a pump is disposed inside an ink supplying container (liquid storing unit), is disclosed in JP-A-9-150524. In ink jet printer, the pump inside ink supplying container directs ink towards a head side.

In a liquid ejecting apparatus, it is permissible for a flow passage to be in a state of negative pressure by charging the flow passage and the liquid ejecting head with ink and sucking the head at the time of performing a head cleaning operation. However, in the liquid ejecting apparatus disclosed in JP-A-5-185603, if the flow passage is allowed to be in the state of negative pressure, a check valve (downstream side) between the pump and the head opens, so that the negative pressure of the flow passage may become unstable.

With reference to the liquid ejecting apparatus disclosed in JP-A-9-150524, since the pump is disposed in the liquid storing unit, all of the head and the flow passage need to be in the state of negative pressure. Therefore, the negative pressure of the flow passage may become unstable.

### SUMMARY

An advantage of some aspects of the invention is to provide a liquid transporting method and a method of cleaning a liquid ejecting apparatus capable of stabilising a state of negative pressure of a flow passage.

According to an aspect of the invention, there is provided a liquid transporting method in a liquid ejecting apparatus having a fluid ejecting head with a nozzle, a liquid storing unit connected through a flow passage to the fluid ejecting head, and a suction unit sucking an inner portion of the nozzle from a nozzle opening side; wherein a portion of the flow passage is used as a pump chamber, and a pump driven to change an internal volume of the pump chamber and an output valve opened only at the time when the output valve is pressed from the pump are provided; the liquid transporting method comprising: performing choke suction when charging the pump with the liquid, and performing a suction operation of sucking the inner portion of the nozzle by using the suction unit, and then, performing a transmission operation of pressing the liquid from the pump towards the output valve.

According to the configuration, since the output valve is not opened during the suction operation, a liquid transporting method capable of stabilising a negative pressure of the flow passage to be stabilized can be implemented.

In addition, since the pump and the output valve are provided in the flow passage, a volume of the flow passage can be reduced, so that a load applied to the suction unit can be reduced.

In addition, the choke suction may be performed several times.

According to the configuration, since the liquid can be repetitively transmitted, the pump volume can be reduced, thereby allowing the pump size to be reduced.

In addition, after the choke suction is performed several times, normal suction of performing only the suction operation may be performed.

According to the configuration, since the amount of liquid in the flow passage can be adjusted, a liquid transporting method capable of obtaining uniform liquid ejection characteristics of the nozzle can be implemented.

In addition, after the transmission operation, the diaphragm pump may be charged with the liquid. According to the configuration, since the next transmission operation can be rapidly performed, a liquid transporting method capable of charging the head with the liquid in a short space of time can be implemented.

According to another aspect of the invention, there is provided a method of cleaning a liquid ejecting apparatus having a fluid ejecting head with a nozzle, a liquid storing unit connected through a flow passage to the fluid ejecting head, a suction unit sucking an inner portion of the nozzle from a nozzle opening side, a pump driven to change an internal volume of a pump chamber that is a portion of the flow passage, and an output valve opened only at the time when the output valve is pressed from the pump; the method comprising: performing a suction operation of sucking the inner portion of the nozzle by using the suction unit, and then, performing a transmission operation of pressing the liquid from the pump towards the output valve.

According to the configuration, since the output valve is not opened during the suction operation, a method of cleaning a liquid ejecting apparatus capable of stabilising the negative pressure of the flow passage to be stabilized can be implemented.

In addition, since the pump and the output valve are provided in the flow passage, the volume of the flow passage sucked by the suction unit can be reduced, so that a load applied to the suction unit can be reduced.

In addition, since the amount of the liquid transmitted into the flow passage can be adjusted by the pump, the cleaning can be performed with a suitable amount of liquid.

According to another aspect of the invention, there is provided a method of cleaning a liquid ejecting apparatus having a fluid ejecting head with a nozzle, a liquid storing unit connected through a flow passage to the fluid ejecting head, a suction unit sucking an inner portion of the nozzle from a nozzle opening side, a pump driven to change an internal volume of a pump chamber that is a portion of the flow passage, and an output valve opened only at the time when the output valve is pressed from the pump; the method comprising: charging the pump with the liquid; and performing a suction operation of sucking the inner portion of the nozzle by using the suction unit, and then, selecting one of a choke cleaning operation where a transmission operation of pressing the liquid from the pump towards the output valve is performed and a normal cleaning operation where only the suction operation is performed, wherein, in the case where the choke cleaning operation is selected, the choke cleaning operation and the normal cleaning operation are performed consecutively, and wherein, in the case where the normal cleaning operation is selected, only the normal cleaning operation is performed.

According to the configuration, since the cleaning operation can be selected according to a degree of deterioration in the liquid ejection characteristics of the nozzles, a method of cleaning a liquid ejecting apparatus capable of efficiently performing the cleaning the nozzles can be implemented.

In addition, since the amount of the liquid transmitted into the flow passage can be adjusted by the pump, the cleaning can be performed with a suitable amount of liquid.

### BRIEF DESCRIPTION OF THE DRAWINGS

The invention will be described with reference to the accompanying drawings, wherein like reference numbers represent like elements.

FIG. 1 is a perspective view illustrating a configuration of a printer.

FIG. 2 is a cross-sectional view showing a configuration of a recording head.

FIG. 3 is a cross-sectional view depicting a configuration of main components of the recording head.

FIG. 4 is a diagrammatic view illustrating configurations of the recording head, an ink cartridge, and an ink droplet sensor.

FIG. 5 is an enlarged view showing a diaphragm pump and a periphery thereof.

FIGS. 6A-6B are views depicting an operational principle of the diaphragm pump.

FIG. 7 is a diagrammatic cross-sectional view showing a capping mechanism.

FIG. 8 is a block diagram showing an electrical configuration of the printer.

FIG. 9 is a schematic flowchart showing an initial charging operation.

FIG. 10 is a flowchart showing details of the initial charging operation.

FIGS. 11A-11E are views showing operations of a diaphragm pump and a periphery thereof in the initial charging operation.

FIGS. 12A-12B are views showing operations of a diaphragm pump and a periphery thereof in the initial charging operation.

FIG. 13 is a flowchart showing details of a pump engagement operation.

FIG. 14 is a flowchart showing details of a main suction operation.

FIG. 15 is a flowchart showing details of a suction supplementary-supplying operation.

FIG. 16 is a flowchart showing details of a vacant suction operation.

FIG. 17 is a flowchart showing details of a manual cleaning operation.

### DESCRIPTION OF EXEMPLARY EMBODIMENTS

Hereinafter, a liquid transporting method in a liquid ejecting apparatus and a method of cleaning a liquid ejecting apparatus according to the invention will be described with reference to the accompanying drawings. In the embodiment, an ink jet printer (hereinafter, referred to as a printer) is exemplified as the liquid ejecting apparatus.

### Liquid Transporting Method

First, configurations of the printer and a liquid transporting method at the time of recording are described.

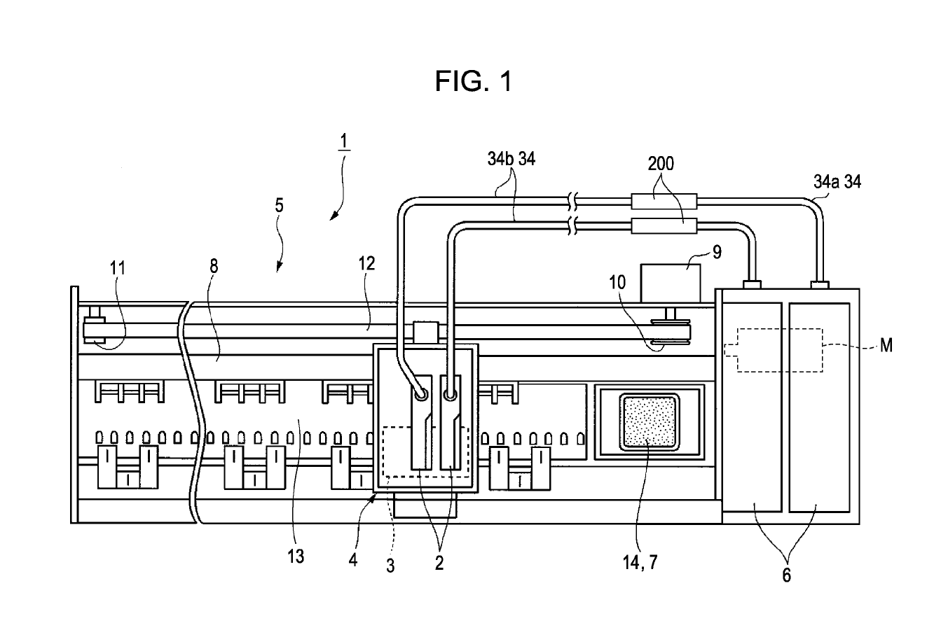

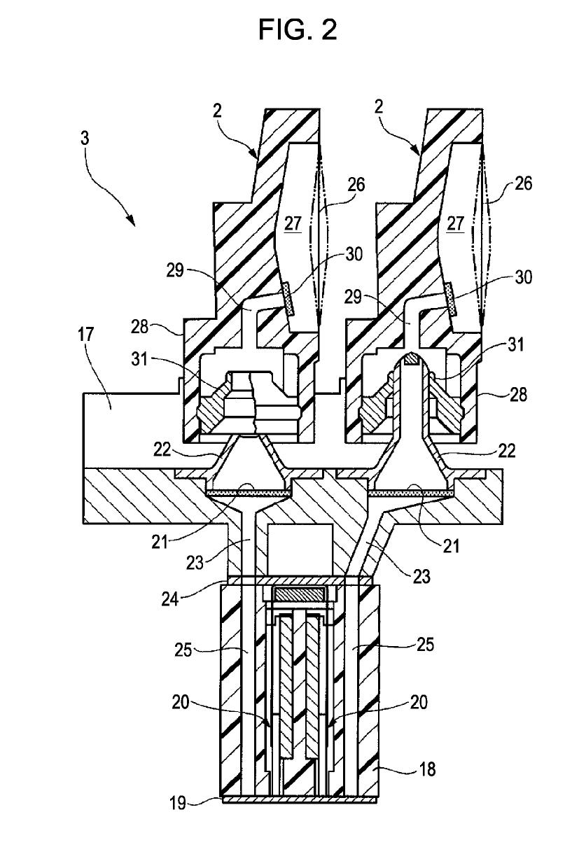

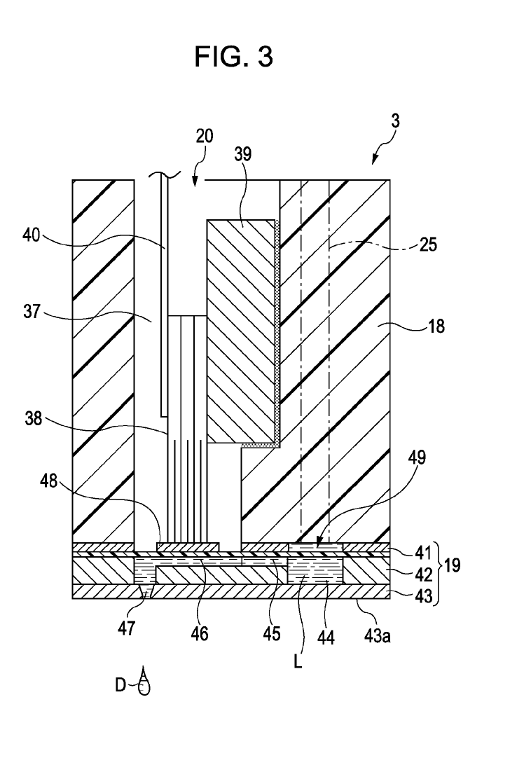

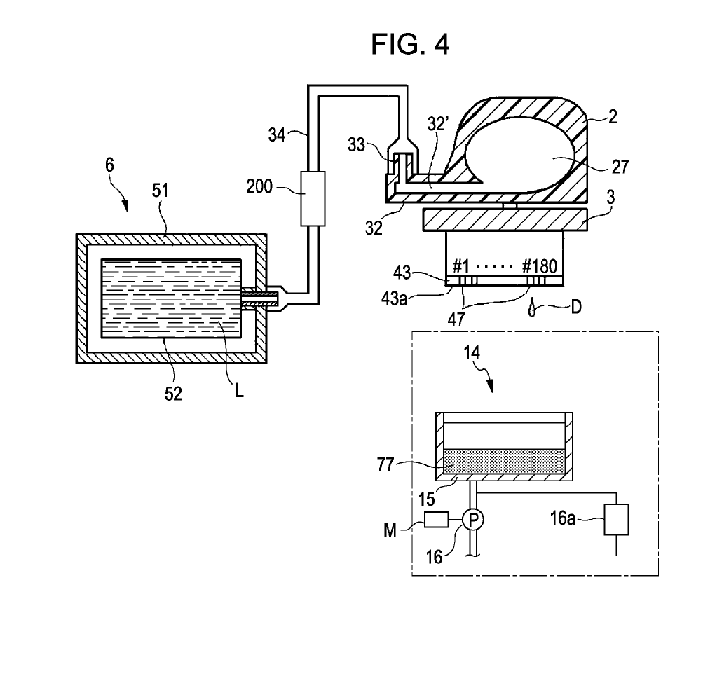

FIG. 1 is a partially exploded view showing a schematic configuration of the printer 1. FIG. 2 is a diagrammatic cross-sectional view showing a configuration of a recording head (fluid ejecting head) 3. FIG. 3 is a diagrammatic cross-sectional view showing main components of the recording head 3. FIG. 4 is a diagrammatic view showing configurations of the recording head 3 and an ink cartridge (liquid storing unit) 6.

The printer 1 is mainly constructed with a carriage 4, on which a sub tank 2 and the recording head 3 are mounted, and a printer main body 5.

The printer main body 5 is provided with a carriage moving mechanism 65 (refer to FIG. 2) by which the carriage 4 is allowed to move in a reciprocating manner, a sheet transporting mechanism 66 (refer to FIG. 2) which transports a recording sheet (not shown), a capping mechanism 14 which performs a cleaning operation on the recording head 3, and the ink cartridge 6 which stores an ink L to be supplied to the recording head 3.

The carriage moving mechanism 65 is constructed with a guide shaft 8 that is disposed along the width of the printer main body 5, a pulse motor 9, a driving pulley 10 that is connected to a rotation shaft of the pulse motor 9 to be driven to rotate by the pulse motor 9, an idling pulley 11 that is disposed at the side opposite to the driving pulley 10 along the width of the printer main body 5, and a timing belt 12 that is suspended between the driving pulley 10 and the idling pulley 11 and connected to the carriage 4.

In addition, the carriage 4 is configured to move in a reciprocating manner along the guide shaft 8 in a main scan direction by driving the pulse motor 9.

In addition, the sheet transporting mechanism 66 is constructed with a sheet transporting motor M or a sheet transporting roller (not shown) that is driven to rotate by the sheet transporting motor M so that the recording sheet is allowed to cooperate with the recording (letter-printing and image-printing) operation so as to be sequentially transmitted on a platen 13.

As shown in FIGS. 3 and 4, the recording head 3 includes an introducing needle unit 17, a head case 18, a flow passage unit 19, and an actuator unit 20 as the main components.

Two ink introducing needles 22 are laterally parallel to one other and are mounted on the top surface of the introducing needle unit 17 so that filters 21 are interposed. A sub tank 2 is disposed to each of the ink introducing needles 22. In addition, ink introducing paths 23 corresponding to the ink introducing needles 22 are formed in an inner portion of the introducing needle unit 17.

The upper end of each of the ink introducing paths 23 communicates with each of the ink introducing needles 22 with the filter 21 interposed therebetween, and the lower end thereof communicates with each of case flow passages 25 formed in an inner portion of the head case 18 with a packing 24 interposed therebetween.

In addition, since the printer 1 of the embodiment is configured to use two types of ink, two sub tanks 2 are disposed. However, it should be noted that the invention can be adapted to a configuration where three or more types of ink are used.

The sub tank 2 is moulded by using a resin material such as polypropylene. A concave portion that is to be used as the ink chamber 27 is formed in each of the sub tank 2. By adhering a transparent elastic sheet 26 to the opening surface of the concave portion, the ink chamber 27 is partitioned.

In addition, needle connection portions 28 into which ink introducing needles 22 are inserted are formed so as to protrude downwardly from the lower portions of the sub tanks 2. The ink chamber 27 in each of the sub tanks 2 has the shape of a shallow-bottomed bowl. An upstream side opening of the connection flow passage 29 that communicates with the needle connection portion 28 is formed at the position slightly below centre thereof in the side surface. A tank-portion filter 30 that filters the ink L is disposed to the upstream side opening.

Sealing members 31, into which the ink introducing needles 22 are liquid-tightly inserted, are inserted into the inner spaces of the needle connection portions 28. As shown in FIG. 4, an extension portion 32 having a communicating groove portion 32′ that communicates with the ink chamber 27 is formed in each of the sub tanks 2. An ink inlet 33 is disposed to protrude from the top surface of the extension portion 32.

An ink supplying tube (flow passage) 34b (34) that supplies the ink L stored in the ink cartridge 6 is connected to the ink inlet 33. Therefore, the ink L transmitted through the ink supplying tube 34b flows from the ink inlet 33 through the communicating groove portion 32′ into the ink chamber 27.

The elastic sheet 26 can be deformed in directions in order to contract and expand the ink chamber 27. In addition, due to a dampener function according to the deformation of the elastic sheet 26, a change in pressure of the ink L is absorbed. In other words, due to the operation of the elastic sheet 26, the sub tank 2 functions as a pressure dampener. Accordingly, the ink L is supplied to the recording head 3 side in a state where a change in pressure in the sub tank 2 is absorbed.

The head case 18 is a hollow box shaped member made of a synthetic resin material. The flow passage unit 19 is attached to the lower end surface of the head case 18. The actuator unit 20 is received in a receiving space portion 37 formed in an inner portion of the head case 18. The introducing needle unit 17 is mounted on the upper end surface opposite to the flow passage unit 19 in the state where the packing 24 is interposed.

Case flow passages 25 are formed to penetrate the inner portion of the head case 18 in the height direction. The upper ends of the case flow passages 25 communicate with the ink introducing paths 23 of the introducing needle unit 17 with the packing 24 interposed therebetween.

In addition, the lower ends of the case flow passages 25 communicate with a common ink chamber 44 inside the flow passage unit 19. Accordingly, the ink L introduced from the ink introducing needles 22 is supplied through the ink introducing paths 23 and the case flow passages 25 towards the common ink chamber 44.

The actuator unit 20 received inside the receiving space portion 37 of the head case 18 is constructed with a plurality of piezoelectric vibrators 38 that are pectinately aligned, a fixing plate 39 to which the piezoelectric vibrators 38 are attached, and a flexible cable 40 as a wire member that applies driving signals from a main body side of the printer to the piezoelectric vibrators 38. The fixed end portion of each piezoelectric vibrator 38 is attached on the fixing plate 39, and the free end portion thereof protrudes outwardly from the front end surface of the fixing plate 39. In other words, each of the piezoelectric vibrators 38 is mounted in a so-called cantilever state on the fixing plate 39.

In addition, the fixing plate 39 that supports the piezoelectric vibrators 38 is made of, for example, stainless steel having a thickness of about 1 mm. In addition, the actuator unit 20 is received and fixed inside the receiving space portion 37 by adhering the rear surface of the fixing plate 39 to the surface of a case inner wall which partitions the receiving space portion 37.

The flow passage unit 19 is integrally manufactured by laminating components of the flow passage unit, that is, a vibrating plate 41, a flow passage substrate 42, and a nozzle substrate 43; and adhering the laminated components with an adhesive. The flow passage unit 19 is an element constituting a series of ink flow passages from the common ink chamber 44 through the ink supplying opening 45 and the pressure chamber 46 to the nozzle 47. The pressure chamber 46 is formed as an elongated chamber in a direction perpendicular to the alignment direction of the nozzles 47.

In addition, the common ink chamber 44 is a chamber that communicates with the case flow passages 25 to introduce the ink L from the ink introducing needles 22.

In addition, the ink L introduced to the common ink chamber 44 is distributed through the ink supplying openings 45 to the pressure chambers 46.

The nozzle substrate 43 disposed to the bottom portion of the flow passage unit 19 is a metallic thin plate member in which a plurality of the nozzles 47 are formed in a column array at a pitch (for example, 180 dpi) corresponding to a dot forming density. The nozzle substrate 43 according to the embodiment is manufactured by using a stainless steal plate member. In the embodiment, a total of 22 columns of the nozzles 47 corresponding to each sub tank 2 are formed in parallel. One nozzle column includes, for example, 180 nozzles 47.

The flow passage substrate 42 that is disposed between the nozzle substrate 43 and the vibrating plate 41 is a plate member that is partitioned into an ink flow passage portion; more specifically, the common ink chamber 44 and ink supplying opening 45 and a space portion that is the pressure chamber 46.

The flow passage substrate 42 is manufactured by performing an anisotropic etching process on a silicon wafer that is a crystalline material. The vibrating plate 41 is a double-structured composite plate member that is formed by laminating an elastic film on a metallic support plate made of, for example, stainless steel. By removing a portion of the support plate by etching or the like, an island portion 48 to which the front end surface of the piezoelectric vibrator 38 is attached is formed in a portion of the vibrating plate 41 corresponding to the pressure chamber 46. This portion functions as the diaphragm portion. In other words, the vibrating plate 41 is configured to elastically deform the elastic film around the island portion 48 depending on the operation of the piezoelectric vibrator 38. In addition, the vibrating plate 41 can also function as a compliance portion 49 that is formed by sealing the one opening surface of the flow passage substrate 42. A portion corresponding to the compliance portion 49 is constructed with only the elastic film that is formed by removing the support plate by the etching similarly to the diaphragm portion.

In addition, in the recording head 3, if the driving signal is applied through the flexible cable 40 to the piezoelectric vibrator 38, the piezoelectric vibrator 38 is expanded and contracted in the longitudinal direction of the device, so that the island portion 48 is moved in the direction approaching towards or being separated from the pressure chamber 46. Therefore, the volume of the pressure chamber 46 is changed, so that a change in pressure of the ink L in the pressure chamber 46 occurs. Due to the change in pressure, ink droplets D are ejected from the nozzle 47.

As shown in FIG. 4, the ink cartridge 6 is constructed with a case member 51 formed in a hollow box shape and an ink pack 52 made of a plastic material. The ink pack 52 is contained in a containing chamber inside the case member 51. The ink cartridge 6 communicates with the one end portion of the ink supplying tube (flow passage) 34a (34).

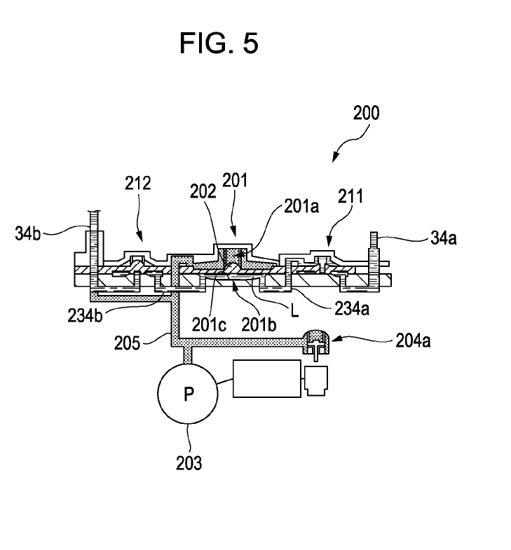

In addition, a diaphragm pump 200, an input valve 211, and an output valve 212 are disposed in the ink supplying tube 34 connecting the recording head 3 and the ink cartridge 6. FIG. 5 is an enlarged view showing the diaphragm pump 200 at a periphery thereof. The input valve 211 is disposed between the diaphragm pump 200 and the ink cartridge 6, and the input side thereof is connected to the ink supplying tube 34a. The output valve 212 is disposed between the diaphragm pump 200 and the recording head 3, and the output side thereof is connected to the ink supplying tube 34b.

The input valve 211 is a check valve that allows the ink L to flow only in the direction from the input side (ink cartridge 6 side) towards the output side (diaphragm pump 200 side).

The output valve 212 is opened to allow the ink L to flow from the input side (diaphragm pump 200 side) to the output side (recording head 3 side) only if the output valve 212 is pressed from the diaphragm pump 200 side. Therefore, even in the case where the output side is in a state of negative pressure and the input side is in a state of relatively high pressure, the output valve 212 cannot be opened. In addition, in the case where the output side is in a state of higher pressure than the input side, the output valve 212 also cannot be opened.

The diaphragm pump 200 is installed so as to transmit the ink L from the ink cartridge 6 to the recording head 3. The diaphragm pump 200 includes a pump chamber 201, a diaphragm suction pump 203, an atmospherically-opened valve 204a, and a suction tube 205. A diaphragm 202 is installed inside the pump chamber 201. As shown in FIG. 5, the diaphragm 202 partitions the pump chamber 201 into an upper space 201a and a lower space 201b.

The upstream side of the lower space 201b is connected through the ink supplying tube 234a (34) to the output side of the input valve 211. On the other hand, the downstream side of the lower space 201b is connected through the ink supplying tube 234b (34) to the input side of the output valve 212.

The upper space 201a is connected through the suction tube 205 to the diaphragm driving pump 203 and the atmospherically-opened valve 204a.

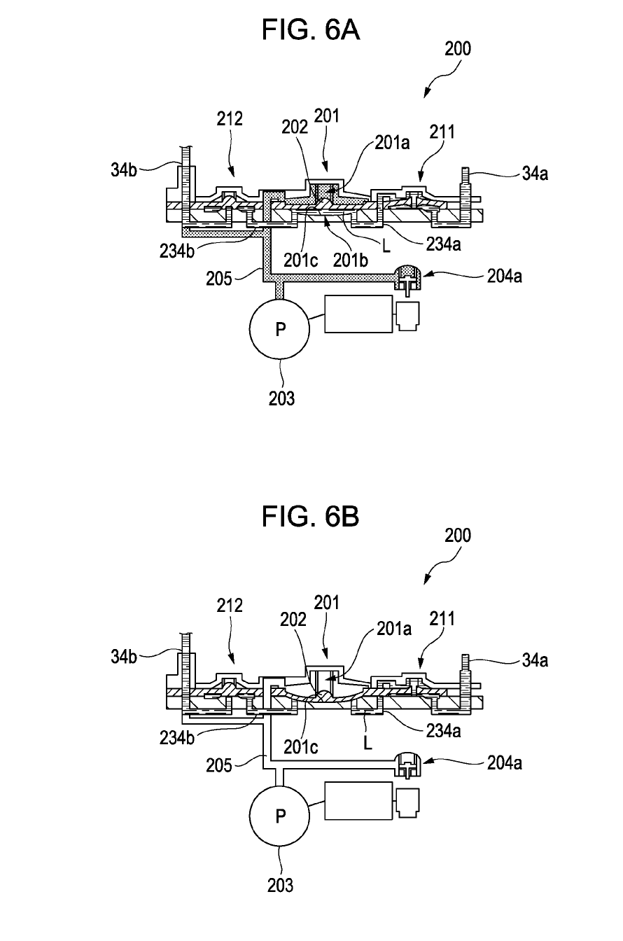

Now, the operational principle of the diaphragm pump 200 is described. FIG. 6 is a view for explaining an operational principle of the diaphragm pump 200. At first, an operation of charging the lower space 201b with the ink L is described. First, the diaphragm suction pump 203 is driven to allow the suction tube 205 and the upper space 201a to be in a state of negative pressure. Therefore, the diaphragm 202 is lifted up to the upper space 201a. Accordingly, the volume of the hermetically sealed lower space 201b is increased, so that the pressure of the lower space is lowered. As a result, the input side of the input valve 211 is at a higher pressure than the output side thereof, so that the input valve 211 is opened to allow lower space 201b to be charged with ink L (refer to FIG. 6A).

Next, an operation of transmitting the ink L from the lower space 201b towards the recording head 3 is described. First, in the state where the diaphragm 202 is lifted up (refer to FIG. 6A), the suction of the suction tube 205 by the diaphragm suction pump 203 is allowed to stop. In addition, the atmospherically-opened valve 204a is opened, so that the suction tube 205 and the upper space 201a are in the atmospherically-opened state. Therefore, the force of lifting up the diaphragm 202 is removed, so that the diaphragm 202 can be moved down to the bottom wall 201c of the lower space 201b by a spring force thereof. Accordingly, the ink L charged in the lower space 201b is pressed towards the output valve 212. At this time, the output valve 212 pressed from the pump chamber 201 side is opened, the ink L is transmitted towards the recording head 3 (refer to FIG. 6B).

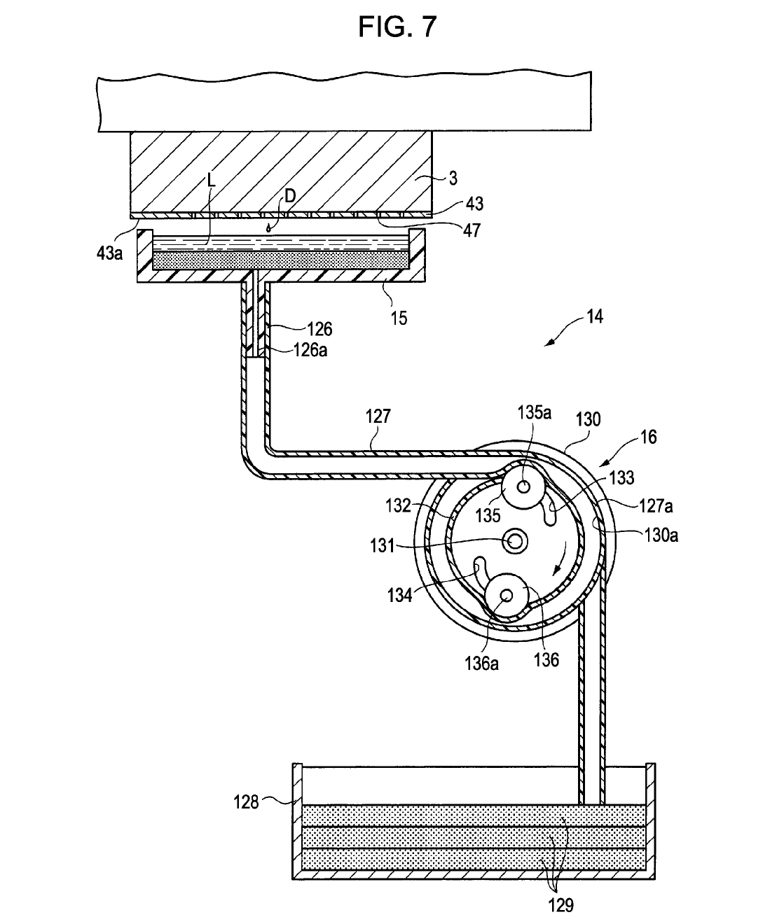

FIG. 7 is a diagrammatic cross-sectional view showing the capping mechanism 14. As shown in FIG. 7, the capping mechanism 14 includes a cap member 15, a suction pump 16, an atmospherically-opened valve 16a, a discharging tube 127, and a waste ink tank 128. The cap member 15 and the waste ink tank 128 are connected to each other through the discharging tube 127. The suction pump 16 is disposed along the discharging tube 127.

The cap member 15 is a tray-shaped member of which the upper surface is opened. The cap member 15 is manufactured by using an elastic material such as an elastomer. An ink absorber 77 is disposed inside the cap member 15. The ink absorber 77 functions by increasing the retaining force of retaining the ink L and is manufactured by using, for example, a non-woven fabric such as a felt. The ink droplets D sucked from the nozzles 47 are absorbed and retained by the ink absorber 77.

In the case where the power is off or in the case where the recording operation is not performed for a long time, the carriage 4 is located at a predetermined home position. The home position exists in the moving range of the carriage 4 and is set in an end area outside the recording area. In the case where the carriage 4 is located in the home position, the cap member 15 is abutted to the surface (nozzle opening surface 43a) of the nozzle substrate 43 (refer to FIG. 3) of the recording head 3, so that the nozzle opening surface 43a is sealed.

In addition, a discharging unit 126 that discharges the ink L collected in the cap member 15 is disposed to protrude downwardly from the bottom wall of the cap member 15. A discharging passage 126a is formed inside the discharging unit 126.

The one end portion of the discharging tube 127 made of a flexible material is connected to the discharging unit 126, and the other end portion of the discharging tube 127 is inserted into the waste ink tank 128.

A waste ink absorbent material 129 made of a porous material is contained in the waste ink tank 128. The ink L transmitted from the cap member 15 is absorbed by the waste ink absorbent material 129. In addition, although not shown, the waste ink tank 128 is disposed under the platen 13 (opposite side of the carriage 4) in FIG. 1.

In the embodiment, a tube-pump type suction pump 16 is employed. The suction pump 16 has a cylindrical case 130. A pump foil 132 having a circular shape is received in the case 130 so that the pump foil 132 can rotate around a foil shaft 131. In addition, an intermediate portion 127a of the discharging tube 127 is received along the inner circumferential wall 130a of the case 130.

In the pump foil 132, a pair of roller guiding grooves 133 and 134 having an outwardly-expanding arc shape are formed to face each other with the foil shaft 131 interposed. The one end of each of the roller guiding grooves 133 and 134 is located at the outer circumferential side of the pump foil 132, and the other end is located at the inner circumferential side of the pump foil 132. In other words, the two roller guiding grooves 133 and 134 are expanded to be gradually separated from the outer circumferential portion of the pump foil 132 acting as guides from the one end to the other end.

In the two roller guiding grooves 133 and 134, a pair of rollers 135 and 136 as pressing units are penetrated and supported by rotation shafts 135a and 136a. In addition, the two rotation shafts 135a and 136a are designed to slidably move along the corresponding roller guiding grooves 133 and 134.

Operations of the suction pump 16 are now described. If the pump foil 132 is rotated in a forwardly direction (arrow direction), the two rollers 135 and 136 are moved to the one end sides of the roller guiding grooves 133 and 134 (outer circumferential side of the pump foil 132) to rotate and sequentially press the intermediate portion 127a of the discharging tube 127 from the cap member 15 side to the waste ink tank 128 side. Due to the rotation, the inner portion of the discharging tube 127 at the upstream side (cap member 15 side) of the suction pump 16 is in the state of negative pressure. Therefore, the ink L collected in the cap member 15 is transmitted to the waste ink tank 128.

In addition, if the pump foil 132 is rotated in a backwardly direction (direction opposite to the arrow direction), the two rollers 135 and 136 are moved to the other end sides of the roller guiding grooves 133 and 134 (inner circumferential side of the pump foil 132). Due to the movement, the two rollers 135 and 136 are weakly attached to the intermediate portion 127a of the discharging tube 127, so that the depressurized state of the inner portion of the discharging tube 127 is released.

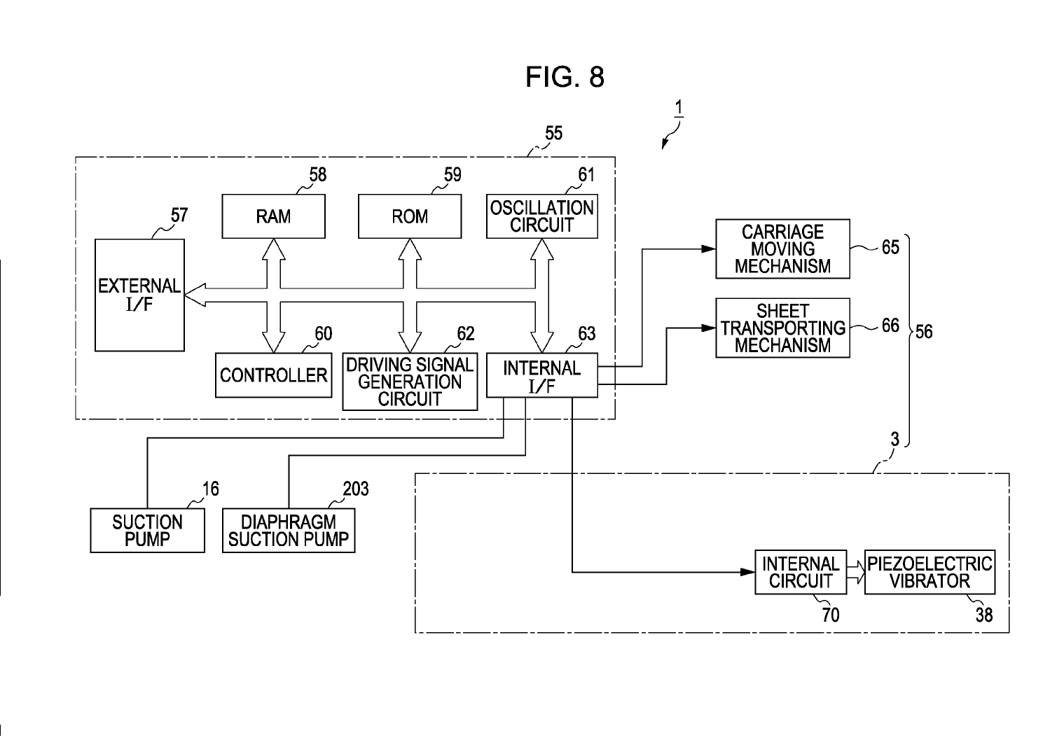

FIG. 8 is a block diagram showing an electrical configuration of the printer 1. The printer 1 according to the embodiment includes a printer controller 55 and a printer engine 56.

The printer controller 55 includes an external interface (external I/F) 57 to which print data is input from an external apparatus such as a host computer, a RAM 58 which stores various data, a ROM 59 which stores control programs for various control processes, a controller 60 which performs overall controlling of components according to the control programs stored in the ROM 59, an oscillation circuit 61 which generates a clock signal, a driving signal generation circuit 62 which generates a driving signal to be applied to the recording head 3, and an internal interface (internal I/F) 63 which outputs ejecting data that are obtained by expanding the print data dot by dot or the driving signal to the recording head 3.

The print engine 56, the suction pump 16, and the diaphragm suction pump 203 are connected to the internal interface 63, and the operations thereof are controlled by the controller 60.

The print engine 56 includes the recording head 3, the carriage moving mechanism 65, and the sheet transporting mechanism 66.

The recording head 3 includes an internal circuit 70 and the piezoelectric vibrator 38. Driving signals and ejecting data output from the internal interface 63 are output to the internal circuit 70 of the recording head 3. The internal circuit 70 drives the piezoelectric vibrator 38 based on the driving signals and ejecting data, so that ink droplets D are ejected from the nozzles 47.

### Initial Charging Operation

Next, a liquid transporting method at the time of an initial charging operation is described. The initial charging operation is an operation of charging the recording head 3 with the ink L when the ink cartridge 6 is mounted on the printer 1 for the first time or when the ink cartridge 6 is replaced.

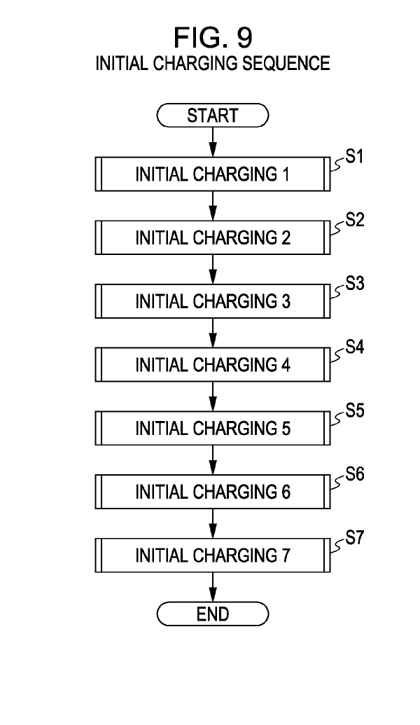

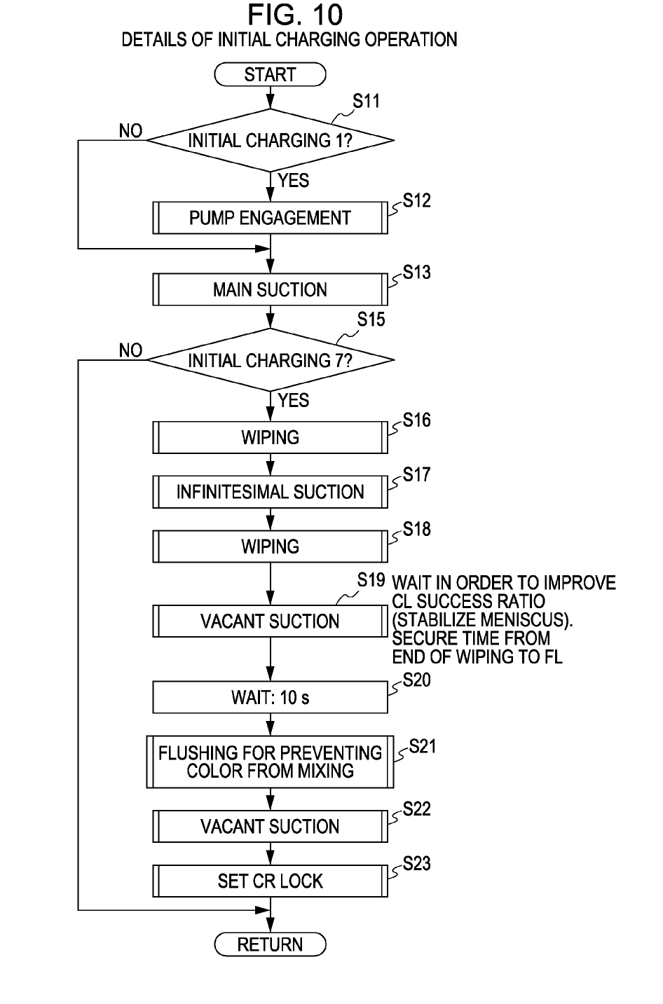

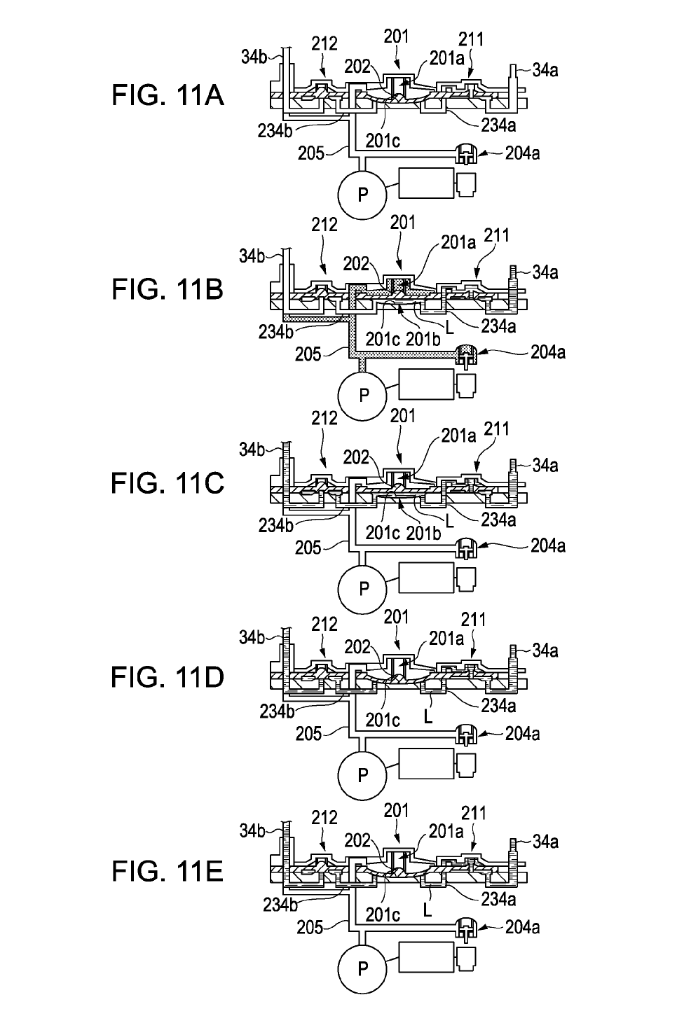

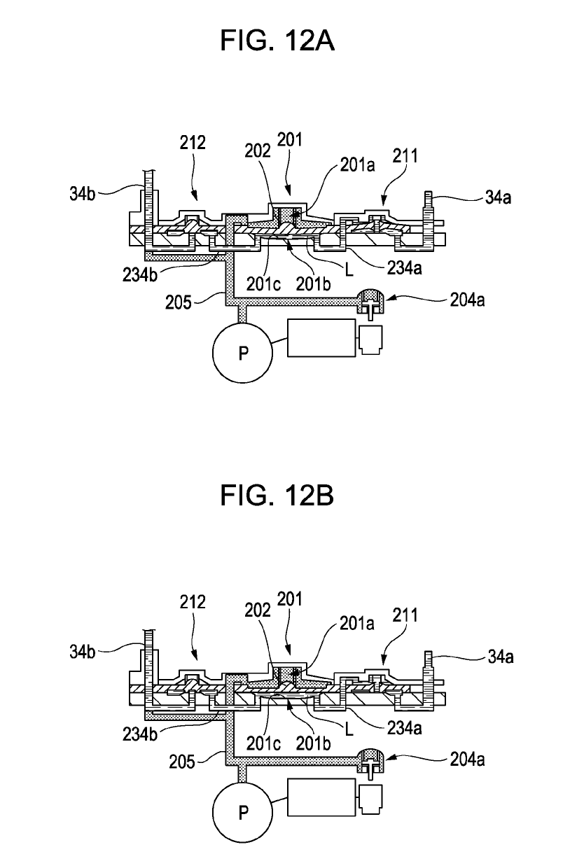

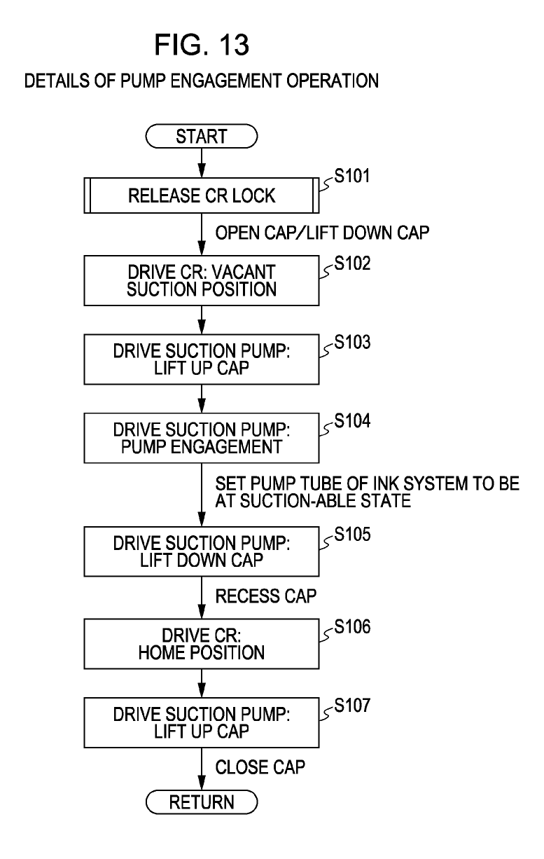

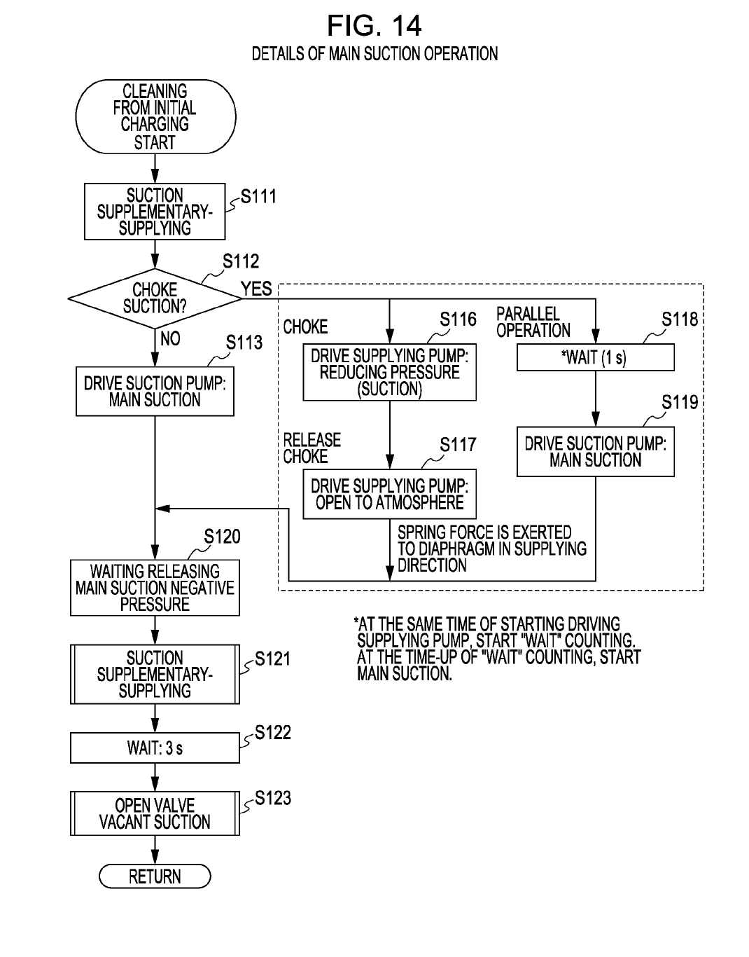

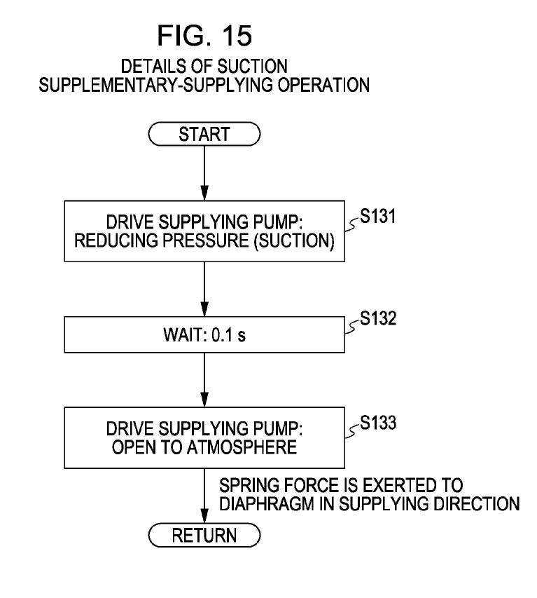

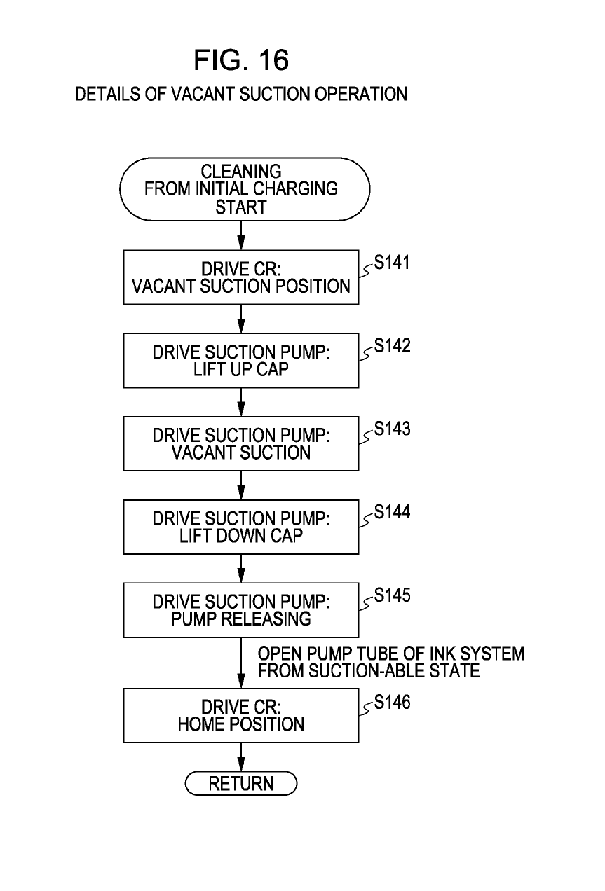

FIG. 9 is a schematic flowchart showing the initial charging operation. FIG. 10 is a flowchart showing details of the initial charging operation. FIGS. 11 and 12 are views showing operations of a diaphragm pump 200 and a periphery thereof in the initial charging operation. FIG. 13 is a flowchart showing details of a pump engagement operation. FIG. 14 is a flowchart showing details of a main suction operation. FIG. 15 is a flowchart showing details of a suction supplementary-supplying operation. FIG. 16 is a flowchart showing details of a vacant suction operation.

In addition, a program for the initial charging operation is stored in the ROM 59 (refer to FIG. 7) in the printer controller 55. At the time of performing the initial charging operation, the program that is read out on the RAM 58, which is the working area, is executed by the controller 60.

The initial charging operation is implemented by sequentially performing steps of first to seventh initial charging operations S1 to S7 (refer to FIG. 9). Next, as shown in FIG. 10, in each of the initial charging operations, a step S12 of allowing the suction pump 16 to be in the drivable state, a step S13 of performing an operation of sucking the nozzles 47 with the suction pump 16 and an operation of transmitting the ink L from the pump chamber 201, steps S16 and S18 of removing the ink attached on the nozzle opening surface 43a, and vacant suction operations S19 and S22 of discharging the ink L collected in the cap 15 to the waste ink tank 128 are performed.

If the process proceeds to the initial charging operation, first, the step S11 is performed. The step S11 is a step of determining whether or not the current step is the first initial charging operation S1. As a result, if the current step is the first initial charging operation S1, the process proceeds to the step S12. As shown in FIG. 11A, at the time of performing the step S11, the upper space 201a is in the atmospherically-opened state, and the diaphragm 202 is abutted to the bottom wall 201c.

### Pump Engagement Operation

The step S12 is a step of performing the pump engagement operation and a preparation step of allowing the suction pump 16 to be in the suction-able state. As shown in FIG. 13, the pump engagement operation is implemented by performing a step S101 of releasing the locked state of the carriage 4 located in the home position, a step S102 of driving the carriage 4 to move the carriage 4 to a position where the vacant suction operation (refer to FIG. 10) is performed, a step S103 of lifting up the cap 15 to abut the cap 15 on the nozzle opening surface 43a, a step S104 of moving the rollers 135 and 136 of the suction pump 16 to press the intermediate portion 127a of the discharging tube 127, a step S105 of lifting down the cap 15, a step S106 of driving the carriage 4 to move the carriage 4 to the home position, and a step S107 of lifting up the cap 15 to abut the cap 15 on the nozzle opening surface 43a.

Before the pump engagement operation is performed, the carriage 4 is in home position, and the nozzle opening surface 43a is sealed by the cap 15. Next, if the process proceeds to the pump engagement operation; first, step S101 is performed. In the step S101, the cap 15 is moved down to be detached from the nozzle opening surface 43a, and the locked state of the carriage 4 is released.

If the locked state of the carriage 4 is released, the process proceeds to the step S102. In the step S102, the carriage 4 is moved to a position (hereinafter, referred to as a vacant suction position) where the vacant suction is performed. Similarly to the home position, the vacant suction position is set to a predetermined area outside the recording area.

If the carriage 4 is moved to the vacant suction position, the process proceeds to the step S103. In the step S103, the cap 15 is lifted up to seal the nozzle opening surface 43a.

Next, the process proceeds to the step S104. The step S104 is a step of allowing the suction pump 16 to be in the suction-able state. By rotating the pump foil 132 in the forwardly direction (arrow direction) in FIG. 6, the rollers 135 and 136 are moved along the roller guiding grooves 133 and 134 to the outer circumferential side of the pump foil 132. The rollers 135 and 136 moved to the outer circumferential side of the pump foil 132 press the intermediate portion 127a of the discharging tube 127 so as to be in the engaged state. As a result, the suction pump 16 is in the suction-able state.

If the suction pump 16 is allowed to be in the suction-able state, the process proceeds to the step S105. In the step S105, the cap 15 is lifted down, so that the cap 15 is detached from the nozzle opening surface 43a.

Next, the process proceeds to the step S106. In the step S106, the carriage 4 is moved to the home position.

Next, the process proceeds to the step S107. In the step S107, the cap 15 is lifted up to seal the nozzle opening surface 43a.

In this manner, the steps S101 to S107 are performed, so that the pump engagement operation is completed.

### Main Suction Operation

Herein, returning to FIG. 10, the initial charging operation is described in detail. If the pump engagement operation of the step S12 is completed, the process proceeds to the step S13. The step S13 is a step of performing the main suction operation. The main suction operation includes a suction operation of driving the suction pump 16 so as to allow the recording head 3 and the ink supplying tube 34b to be in a negative pressure state, and a transmission operation of pressing the ink L from the pump chamber 201 towards the output valve 212.

Next, the main suction operation is described in detail. As shown in FIG. 14, the main suction operation is implemented by performing a step S111 of performing a suction supplementary-supplying operation, a step S112 of selecting the main suction operation method, steps S113 to S119 of performing the suction operation and the transmission operation, a step S121 of performing the suction supplementary-supplying operation after the suction operation and the transmission operation, and a step S123 of performing a valve-opened vacant suction operation of extracting the ink L collected in the cap 15.

First, the step S111 is described. The step S111 is a step of performing the suction supplementary-supplying operation. The suction supplementary-supplying operation is an operation of pressing the ink L towards the output valve 212 before or after the suction operation and the transmission operation of steps S113 and S116 to S119. In the step S111, the suction supplementary-supplying operation before the main suction operation is performed. As shown in FIG. 15, the suction supplementary-supplying operation is implemented by performing a step S131 of charging the pump chamber 201 with the ink L, a step S132 of stabilizing the ink L in the pump chamber 201, and a step S133 of pressing the ink L towards the output valve 212 in this order.

In the step S131, the pump chamber 201 is charged with the ink L. In the initial state, the diaphragm 202 is pushed on the bottom wall 201c by a spring, and the pump chamber 201 is not charged with the ink L (refer to FIG. 11A). At this time, if the suction tube 205 and the upper space 201a are allowed to be in the negative pressure state by the diaphragm suction pump 203, the diaphragm 202 starts to be moved upwards. Therefore, the lower space 201b is in the negative pressure state, and the output valve 211 is opened, so that the lower space 201b starts to be charged with the ink L. Next, the ink L is charged until the negative pressure of the lower space 201b is released (refer to FIG. 11B). At this time, an amount of the ink charged in the pump chamber 201 is maximized.

Next, the process proceeds to the step S132. The step S132 is a waiting period in which the ink L charged in the lower space 201b is allowed to be stabilized. The waiting time is about 0.1 sec. The measurement of the waiting time can be performed, for example, by a counting circuit that is provided inside the controller 60.

Next, if the waiting period is ended, the process proceeds to the step S133. In the step S133, the ink L charged in the lower space 201b is pressed towards the output valve 212. First, the suction of the diaphragm suction pump 203 is allowed to stop, and the atmospherically-opened valve 204a is opened, so that the suction tube 205 and the upper space 201a are in the atmospherically-opened state. Therefore, the diaphragm 202 is pushed towards the bottom wall 201c by a spring force, so that the ink L charged in the lower space 201b is pressed towards the output valve 212. As a result, the output valve 212 is opened, so that the ink L is transmitted to the ink supplying tube 34b (refer to FIGS. 11C and 11D).

In this manner, the steps S131 to S133 are performed, so that the suction supplementary-supplying operation is completed.

In addition, at the time of starting the initial charging operation, air residing between the ink cartridge 6 and the pump chamber 201 as well as the ink L are transmitted. In addition, the steps S131 to S133 may be repeated several times.

Returning to FIG. 14, the main suction operation is described. If the suction supplementary-supplying operation is completed, the process proceeds to the step S112. The step S112 is a step of selecting a main suction operation method. More specifically, choke suction of performing the transmission operation after the suction operation is performed or normal suction of performing only the suction operation is selected.

In the embodiment, the choke suction is selected in the first to fifth initial charging operations S1 to S5, and the normal suction is selected in the sixth and seventh initial charging operations S6 and S7.

In the case where the choke suction is selected in the step S112, the steps S116 to S119 are performed. The steps S116 and S117 are steps corresponding to the transmission operation, and the steps S118 and S119 are steps corresponding to the suction operation.

First, the step S116 is a step of charging the pump chamber 201 with the ink L. The operation of charging with the ink L is the same as the operation of charging with ink L in the suction supplementary-supplying operation. In other words, the suction tube 205 and the upper space 201a are allowed to be in the state of negative pressure, and the diaphragm 202 is allowed to be lifted upwardly, so that the lower space 201b is charged with the ink L.

In addition, at the same time of the step S116, the step S118 starts. The step S118 is a waiting period until the suction operation in the step S119 starts. The waiting time in the step S118 is about 1 sec.

Next, if the waiting period is ended, the process proceeds to the step S119. In the step S119, the suction operation is performed by the suction pump 16, so that the recording head 3 and the ink supplying tube 34b are in the negative pressure state. In addition, the nozzle opening surface 43a is sealed by the cap 15 from the time when the pump engagement operation of the step S12 is ended. Next, if the recording head 3 and the ink supplying tube 34b are in the negative pressure state, the suction operation stops.

Next, if the suction operation of the step S116 is completed, the process proceeds to the step S117. In the step S117, the transmission operation for the ink L is performed. In other words, the atmospherically-opened valve 204a is opened so that the suction tube 205 and the upper space 201a are in the atmospherically-opened state, and the diaphragm 202 is pushed towards the bottom wall 201c side. As a result, the ink L is pressed towards the output valve 212 (refer to FIG. 11C and 11D). At this time, since the ink supplying tube 34b is in the negative pressure state, the transmitted ink L is strongly flown towards the recording head 3.

If the choke suction operation is completed, the process proceeds to the step S120.

On the contrary, if the normal suction is selected in the step S112, the process proceeds to the step S113. In the step S113, only the suction operation is performed by the suction pump 16. The suction operation of the step S113 is performed in order to adjust the amount of ink in the recording head 3 and the ink supplying tube 34b. During the suction operation, the output valve 212 is opened, and a very small amount of the ink L is sucked from the nozzles 47. In this manner, if the normal suction operation is completed, the process proceeds to the step S120.

In the step S120, the atmospherically-opened valve 16a is opened, so that the cap 15, the recording head 3, and the ink supplying tube 34b are in the atmospherically-opened state. Next, the process proceeds to the step S121.

The step S121 is a step of performing the suction supplementary-supplying operation after the suction operation and the transmission operation. The suction supplementary-supplying operation is the same as that of the step S111. In other words, the diaphragm suction pump 203 is driven by the step S131 to suck the suction pump 205 and the upper space 201a (refer to FIG. 11E), the diaphragm 202 is moved upwards (refer to FIG. 12A), and the lower space 201b is charged with the ink L (refer to FIG. 12B). In addition, the ink L in the pump chamber 201 is stabilized by the step S132, and the ink L is pressed towards the output valve 212 by the step S133.

If the suction supplementary-supplying operation of the step S121 is completed, the process proceeds to the step S122. The step S122 is a waiting period where the ink L in the recording head 3 and the ink supplying tube 34b is stabilized after the suction supplementary-supplying operation. The waiting time in the step S122 is about 3 sec.

If the waiting period of the step S122 is passed, the process proceeds to the step S123. The step S123 is a step of performing the valve-opened vacant suction operation. The valve-opened vacant suction operation is an operation of removing the ink L discharged in the cap 15 by the suction operation in the steps S113 and S119. In the step S120, since the atmospherically-opened valve 16a is opened, the inner portion of the cap 15 is in the atmospherically-opened state. Next, if the suction pump 16 is driven, the ink L collected in the cap 15 is sucked into the discharging tube 127 to be discharged to the waste ink tank 128.

As described hereinbefore, the steps S111 to S123 are performed, so that the main suction operation S13 is completed.

Herein, returning to FIG. 10, the initial charging operation is described in detail. If the main suction operation of the step S13 is completed, the process proceeds to the step S15. The step S15 is a step of identifying which step the initial charging operation is included in. If the operation is one of the first to sixth initial charging operations S1 to S6, the initial charging operation of each step is completed. If the operation is the seventh initial charging operation S7, the process proceeds to the step S16.

The step S16 is a step of performing the wiping operation. The wiping operation is an operation of removing the ink attached on the nozzle opening surface 43a by the suction operation or the like. In the wiping operation, first, the cap 15 is lifted down to be detached from the nozzle opening surface 43a. Next, the nozzle opening surface 43a is moved to the vicinity of a wiper (not shown) installed in the vicinity of the cap 15. Next, by moving the nozzle opening surface 43a while contacting with the wiper, the ink L attached to the nozzle opening surface 43a is removed. The ink L removed by the wiper is collected in the cap 15.

If the wiping operation is completed, the process proceeds to the step S17. In the step S17, the infinitesimal suction operation is performed. The infinitesimal suction operation is a suction operation of suppressing the amount of the sucked ink L in comparison with the time of the main suction operation. In the infinitesimal suction operation, first, the cap 15 is lifted up to seal the nozzle opening surface 43a. Next, similarly to the main suction operation, the suction operation of the suction pump 16 and the transmission operation of the pump chamber 201 are performed, so that the ink L is discharged from the nozzles 47.

If the infinitesimal suction operation is completed, the process proceeds to the step S18. The step S18 is a step of performing the wiping operation after the infinitesimal suction operation. In the step S18, the operations the same as those of the step S16 are performed.

If the wiping operation of the step S18 is completed, the process proceeds to the step S19. The step S19 is a step of performing the vacant suction operation. The vacant suction operation is an operation of removing the ink L collected in the cap 15. In the valve-opened vacant suction operation of the step S123 performed just after the main suction operation, since the cap 15 is continuously attached on the nozzle opening surface 43a, the valve-opened vacant suction operation has the step S120 of allowing the inner portion of the cap 15 to be in the atmospherically-opened state. On the contrary, the vacant suction operation of the step S19 has the step of attaching the cap 15 located at the separated position for performing the wiping operation on the nozzle opening surface 43a. Therefore, the step of allowing the inner portion of the cap 15 to be in the atmospherically-opened state is unnecessary.

Now, the vacant suction operation is described with reference to the flowchart of FIG. 16. If the process proceeds to the vacant suction operation, first, the step S141 is performed. In the step S141, the carriage 4 is moved to the vacant suction position. Next, the process proceeds to the step S142.

In the step S142, the carriage 4 is moved, so that the recording head 3 is moved to a position separated from the capping mechanism 14.

Next, the process proceeds to the step S143 to perform the vacant suction operation. If the suction pump 16 is driven, the ink L in the cap 15 is sucked into the discharging tube 127 to be discharged to the waste ink tank 128.

If the vacant suction operation is completed, the process proceeds to the step S144. In the step S144, the cap 15 is moved down to be detached from the nozzle opening surface 43a.

Next, the process proceeds to the step S145 to allow the suction pump 16 to be in the opened state. In other words, the rollers 135 and 136 are moved along the roller guiding grooves 133 and 134, so that the state where discharging tube 127 is pressed is released.

If the suction pump 16 is in the opened state, the process proceeds to the step S146 to move the carriage 4 to the home position. In this manner, the steps S141 to S146 are performed, so that the vacant suction operation is completed.

Herein, returning to FIG. 10, the initial charging operation is described. If the vacant suction operation is completed, the process proceeds to the step S20. The step S20 is a waiting period for securing a time interval from the time when the wiping operation of the step S18 is completed to the time when the flushing operation of the step S21 starts. The waiting time in the step S20 is about 10 sec.

Next, if the waiting period is ended, the process proceeds to the step S21. In the step S21, a flushing operation is performed. The flushing operation is an operation of driving the piezoelectric vibrators 38 to allow all the nozzles 47 to eject the ink L. In order to prevent color-mixing at the time of the recording operation, the flushing operation is performed to eject from the nozzles 47 ink L color-mixed by the wiping operation. The ink L ejected from the nozzles 47 is collected in the cap 15.

If the flushing operation is completed, the process proceeds to the step S22. The step S22 is a step of performing the vacant suction operation the same time as that of the step S19. By performing the vacant suction operation, the ink L collected in the cap 15 by the flushing operation is discharged into the waste ink tank 128.

Next, if the vacant suction operation of the step S22 is completed, the process proceeds to the step S23. In the step S23, the recording head 3 is capped. The cap 15 is lifted up to seal the nozzle opening surface 43a, so that the carriage 4 is fixed in the home position. In this manner, the steps S11 to S24 are performed, so that the initial charging operation of the recording head 3 and the ink supplying tube 34b with the ink L is completed.

Next, although not shown in the figure, after the initial charging operation is completed, the lower space 201b is charged with the ink L. In addition, the state where the lower space 201b is charged with the ink L is sustained until the recording operation is performed or until the cleaning is performed.

In this manner, by transmitting the ink L, the following effects can be obtained.

The choke suction of performing the transmission operation of the step S117 is performed after performing the suction operation of the step S119. Since the output valve 212 is not opened during the suction operation, the negative pressure of the inner portions of the recording head 3 and the ink suction tube 34b are stabilized.

In addition, the pump chamber 201 and the output valve 212 are provided in ink supplying tube 34 (34a and 34b), so that the area sucked by the suction pump 16 can be reduced. Therefore, a load applied to the suction pump 16 can be reduced.

In addition, the choke suction is performed several times by the steps S1 to S5, so that the ink L can be repetitively transmitted. Therefore, the volume of the pump chamber 201 can be reduced, so that the size of the diaphragm pump 200 can be reduced.

In addition, after the choke suction is performed, the normal suction is performed in the steps S6 and S7, so that the amount of ink in the recording head 3 and the ink supplying tube 34b can be adjusted. Therefore, ink ejection characteristics of the nozzles 47 can be uniform.

In addition, it is preferable that, after the transmission operation, the diaphragm pump is charged with the aforementioned liquid. Therefore, the next transmission operation can be rapidly performed, so that a liquid transporting method capable of charging the head with the liquid in a short time can be implemented.

### Method of Cleaning Liquid Ejecting Apparatus

Next, a method of cleaning the printer 1 is described.

The cleaning operation for the printer 1 is performed at a predetermined time interval just after the power on or during the recording operation.

The cleaning operation for the printer 1 is an operation of recovering the ink ejection characteristics deteriorating caused by the clogging of the nozzles 47 or the bubbles residing in the recording head 3 and the ink supplying tube 34b.

In the embodiment, there are two types of cleaning operations; that is, a choke cleaning operation and a normal cleaning operation. The normal cleaning operation is an operation of performing only the suction operation, and the choke cleaning operation is an operation of performing the transmission operation of transmitting the ink L from the pump chamber 201 after the suction operation by the suction pump 16.

A program executing the cleaning operation is stored in the ROM 59. The program that is read out on the RAM 58, which is the working area, is executed by the controller 60. In addition, the cleaning operation is performed in the state where the carriage 4 is located in the home position or the vacant suction position.

### Normal Cleaning Operation

First, the normal cleaning operation is described. In the normal cleaning operation, the steps the same as those of the normal suction in FIG. 14 are performed. In the normal cleaning operation, a step S111 of performing the suction supplementary-supplying operation and a step S113 of performing the suction operation of the suction pump 16 are performed.

If the process proceeds to the normal cleaning operation, first, the suction supplementary-supplying operation of the step S111 is performed. The suction supplementary-supplying operation is the same as the step S111 and the step S121 of FIG. 14. In other words, the pump chamber 201 is charged with the ink L (step S131), and the charged ink L is pressed towards the output valve 212 (step S133).

If the suction supplementary-supplying operation is completed, the process proceeds to the step S113 to perform the suction operation.

Next, if the suction operation is completed, the process proceeds to the step S120. In the step S120, the atmospherically-opened valve 16a is opened, so that the cap 15 is in the atmospherically-opened state.

Next, the process proceeds to the step S121 to perform the suction supplementary-supplying operation the same as that of the step S111.

Next, the process proceeds to the step S122 to wait until the ink L in the recording head 3 and the ink supplying tube 34b is stabilized. The waiting time in the step S122 is about 3 sec.

Next, the process proceeds to the step S123 to perform the valve-opened vacant suction operation. By performing the valve-opened vacant suction, the ink L collected in the cap 15 in the suction operation is discharged to the waste ink tank 128.

In this manner, the steps S111 to S113 and S120 to S123 are performed, so that the normal cleaning operation is completed.

During the normal cleaning operation, sine the output valve 212 is opened, the internal pressures of the recording head 3 and the ink supplying tube 34b can be stabilized. In addition, since the ink L can be stably supplied from the pump chamber 201, the bubbles residing in the recording head 3 and the ink supplying tube 34b can be easily discharged. Therefore, it is possible to recover ink ejection characteristics of the nozzles 47.

in addition, since the amount of transmitted ink L can be adjusted by the diaphragm pump 200, the cleaning operation can be performed by a suitable amount of ink.

### Choke Cleaning Operation

Next, the choke cleaning operation is described. In the choke cleaning operation, the steps the same as those of the choke suction in FIG. 14 are performed. In the choke cleaning operation, a step S111 of performing the suction supplementary-supplying operation, a step S116 of charging the lower space 201b with the ink L, a step S117 of performing a transmission operation of transmitting the ink L charged in the lower space 201b, and a step S119 of performing the suction operation of the suction pump 16 are performed.

If the process proceeds to the choke cleaning operation, first, the suction supplementary-supplying operation of the step S111 is performed. In other words, after the pump chamber 201 is charged with the ink L, the ink L is pressed towards the output valve 212.

If the suction supplementary-supplying operation is completed, the process proceeds to the step S116. In the step S116, the pump chamber 201 is charged with the ink L. In addition, the step S118 in concurrence with the step S116 is performed. The step S118 is a waiting period for performing the suction operation in the step S119.

Next, if the waiting period is ended, the process proceeds to the step S119 to perform the suction operation. By the suction operation, the recording head 3 and the ink supplying tube 34b are in the negative pressure state.

Next, if the suction operation of the step S116 is completed, the process proceeds to the step S117. In the step S117, the transmission operation is performed, so that the ink L charged in the pump chamber 201 is pressed towards the output valve 212. In addition, the output valve 212 is opened, so that the ink L is transmitted towards the ink supplying tube 34b. At this time, since the recording head 3 and the ink supplying tube 34b are in the negative pressure state, the ink L transmitted to the ink supplying tube 34b is strongly flown.

If the transmission operation is completed, the process proceeds to the step S120. In the step S120, the atmospherically-opened valve 16a is opened, so that the inner portion of the cap 15 is in the atmospherically-opened state.

Next, the process proceeds to the step S121 to perform the suction supplementary-supplying operation the same as that of the step S111.

Next, the process proceeds to the step S122 to wait until the ink L in the recording head 3 and the ink supplying tube 34b is stabilized. The waiting period in the step S122 is about 3 sec.

Next, the process proceeds to the step S123 to perform the valve-opened vacant suction operation. By the valve-opened vacant suction operation, the ink L collected in the cap 15 in the suction operation is discharged into the waste ink tank 128.

In this manner, the steps S111, S112, and S116 to S123 are performed, so that the normal cleaning operation is completed.

If the choke cleaning operation is performed, the output valve 212 is opened during the time of the suction operation of the step S119, so that the negative pressure of the recording head 3 and the ink supplying tube 34b can be sustained to be stabilized.

In addition, if the transmission operation of the step S117 is performed, the ink L is strongly frown in the recording head 3 and the ink supplying tube 34b, so that the clogging of the nozzles 47 can be removed, and the ink ejection characteristics of the nozzles 47 can be recovered.

In addition, the pump chamber 201 and the output valve 212 are provided in the ink supplying tube 34 (34a and 34b), so that the area sucked by the suction pump 16 can be reduced. Therefore, a load applied to the suction pump 16 can be reduced.

In addition, since the amount of transmitted ink L can be adjusted by the diaphragm pump 200, the cleaning operation can be performed by a suitable amount of ink.

in addition, the transmission operation and the suction operation of the steps S116 to S119 may be repeatedly performed. Therefore, although the volume of the pump chamber 201 is reduced, the ink L required for the cleaning operation can be transmitted, so that size of the diaphragm pump 200 can be reduced.

### Manual Cleaning Operation

Next, the manual cleaning operation is described. The manual cleaning operation is an operation of allowing a user of the printer 1 to forcibly perform the cleaning operation.

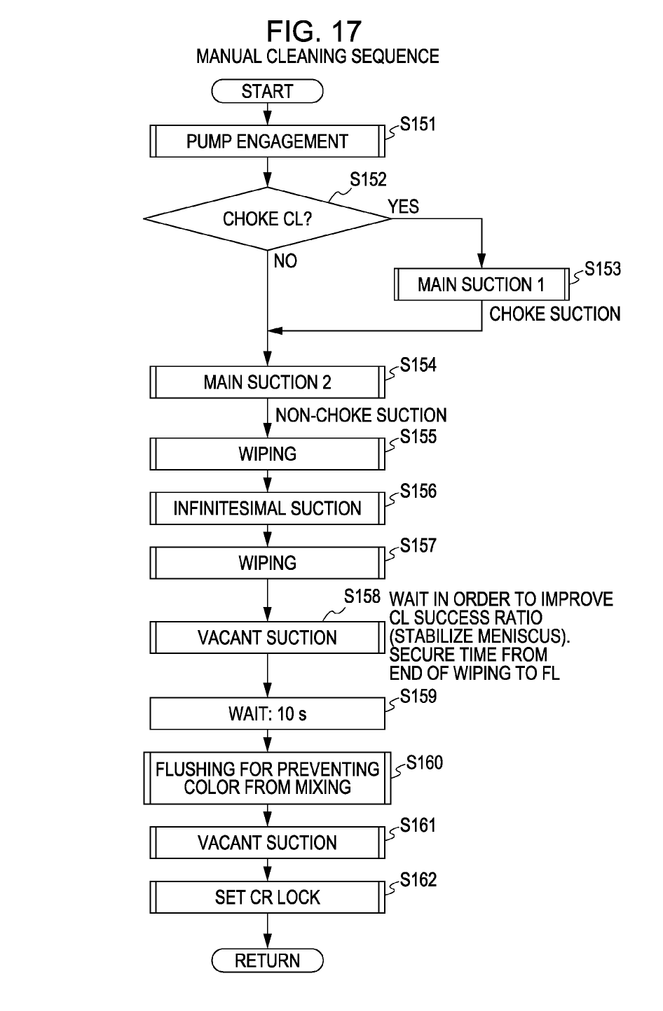

FIG. 17 is a flowchart showing the manual cleaning operation. In the manual cleaning operation, a step S151 of performing the pump engagement operation, a step S152 of selecting the cleaning operation, and steps S153 and S154 of performing the cleaning operation are performed.

If the manual cleaning operation starts, first, the step S151 is performed. The step S151 is a step of performing the pump engagement operation. The pump engagement operation is the same as the step S12 in the initial charging operation in FIG. 10. Therefore, the suction pump 16 is in the suction-able state.

If the pump engagement operation is completed, the process proceeds to the step S152. The step S152 is a step of selecting the cleaning operation. The printer 1 is designed to detect clogged nozzles 47. In the step S152, the cleaning operation is selected according to the number of clogged nozzles 47.

In the case where the number of the clogged nozzles 47 is equal to or larger than a predetermined number, the process proceeds to the step S153 to perform the choke cleaning operation. By performing the choke cleaning operation, the clogging of the nozzles 47 is removed, so that ink ejection characteristics can be recovered.

If the choke cleaning operation is completed, the process proceeds to the step S154 to perform the normal cleaning operation. By performing the normal cleaning operation, the bubbles residing in the recording head 3 and the ink supplying tube 34b are discharged from the nozzles 47.

To the contrary, if the number of clogged nozzles 47 is a predetermined number or less, it is determined that the clogging does not greatly influence on the recording operation, and the process proceeds to the step S154 to perform the normal cleaning operation. Therefore, the bubbles residing in the recording head 3 and the ink supplying tube 34b are discharged from the nozzles 47.

If the normal cleaning operation is completed, the process proceeds to the step S155. The step S155 is a step of performing the wiping operation. By the wiping operation, the ink L attached on the nozzle opening surface 43a during the performing of the cleaning operation is removed. The wiping operation is the same as the operation performed in the step S16 of the initial charging operation.

Next, if the wiping operation is completed, the process proceeds to the step S156 to perform the infinitesimal suction operation. The infinitesimal suction operation is the same as the operation performed in the step S17 of the initial charging operation.

If the infinitesimal suction operation is completed, the process proceeds to the step S157. The step S157 is a step of performing the wiping operation of removing the ink L attached on the nozzle opening surface 43a in the infinitesimal suction operation. The wiping operation is the same as the operation performed in the step S155.

Next, the process proceeds to the step S158 to perform the vacant suction operation. The vacant suction operation of the step S158 is the same as the operation performed in the step S19 in the initial charging operation. By performing the vacant suction operation, the ink L collected in the cap 15 in the cleaning operation and the infinitesimal suction operation is discharged into the waste ink tank 128.

If the vacant suction operation is completed, the process proceeds to the step S159. The step S159 is a waiting period for stabilizing the ink L in the recording head 3 and the ink supplying tube 34b. The waiting time in the step S159 is about 10 sec.

Next, if the waiting period is passed, the process proceeds to the step S160. The step S160 is a step of performing the flushing operation. The flushing operation is the same as the operation performed in the step S21 in the initial charging operation. In other words, the piezoelectric vibrators 38 are driven to eject the ink L from the nozzles 47, so that the color-mixing at the time of the recording operation is prevented.

If the flushing operation is completed, the process proceeds to the step S161 to perform the vacant suction operation. By the vacant suction operation, the ink L collected in the cap 15 in the flushing operation is discharged to the waste ink tank 128.

Next, if the vacant suction operation is completed, the process proceeds to the step S162. In the step S162, the carriage 4 is moved to the home position, so that the nozzle opening surface 43a is sealed with the cap 15. Accordingly, the carriage 4 is in the locked state.

In this manner, the steps S151 to S162 are performed, so that the manual cleaning operation is completed.

By employing the manual cleaning operation, since the cleaning method can be selected according to a degree of clogging of nozzles, the cleaning operation for the nozzles 47 can efficiently be performed.

In addition, in the choke cleaning operation and the normal cleaning operation, the negative pressure in the recording head 3 and the ink supplying tube 34b can be sustained to be stabilized.

In addition, since the amount of transmitted ink L can be controlled by the diaphragm pump 200, the cleaning operation can be performed by a suitable amount of ink.

Although the diaphragm pump is exemplified as the pump in the aforementioned embodiment, the invention is not limited thereto. For example, a piston pump may be used. If a piston pump is employed, the pump chamber is pressed directly by a piston that can move in a reciprocating manner in the pump chamber, and the volume of the pump chamber is changed according to the reciprocating movement of the piston.

Although the ink jet printer is employed in the aforementioned embodiment, a liquid ejecting apparatus of spraying or ejecting a liquid different from ink may be employed. In addition, various liquid ejecting apparatus having a liquid ejecting head of ejecting an infinitesimal amount of liquid droplets may be used. In addition, the liquid droplet denotes a state of the liquid that is ejected from the liquid ejecting apparatus, including a liquid droplet having a trail in a particle shape, a tear shape, or a string shape. In addition, the aforementioned liquid may be any material that can be ejected by the liquid ejecting apparatus. For example, a material in a liquid state is suitable. That is, the material includes a liquid-state material having a high or low viscosity, a fluid-state material such as a sol or gel water, other inorganic solvents, organic solvent, solutions, liquid resins, and liquid metals (metallic solutions), a liquid as a one-state of a material, or a liquid obtained by dissolving particles of functional materials made of solids such as pigments or metallic particles with a solvent and dispersing or mixing. In addition, as a representative example of the liquid, there is an ink described as an example in the embodiment or a liquid crystal. Herein, ink may include various liquid composite materials such as general water-based ink and oil-based ink, a gel ink, and a hot-melt ink. As specific examples of the liquid ejecting apparatus, there are a liquid display, EL (electro-luminance) display, a surface-emitting display, a liquid ejecting apparatus of ejecting a liquid including a dispersed or dissolved liquid of a material such as an electrode material or a colorant used to manufacture a color filter, a liquid ejecting apparatus of ejecting a bio-organic material used to manufacture a bio-chip, a liquid ejecting apparatus of ejecting a liquid that is a specimen used as a precision pipette, a cloth printing apparatus, and a micro dispenser. In addition, a liquid ejecting apparatus of ejecting a lubricant on a precision machine such as a watch or a camera in a pinpoint manner, a liquid ejecting apparatus of ejecting a transparent resin solution such as a UV-cured resin on a substrate in order to manufacture a micro semi-spherical lens (optical lens) used for an optical communication device, or a liquid ejecting apparatus of ejecting an etching solution such an acid or alkali solution in order to etch a substrate may be employed. In addition, the invention can be adapted to any one of the aforementioned ejecting apparatus and a liquid container.

What is claimed is:

1. A liquid transporting method in a liquid ejecting apparatus having a fluid ejecting head having a nozzle, a liquid storing unit connected through a flow passage to the fluid ejecting head, and a suction unit sucking an inner portion of the nozzle from a nozzle opening side, wherein a portion of the flow passage is used as a pump chamber, and a pump driven to change an internal volume of the pump chamber and an output valve opened only at the time when the output valve is pressed from the pump are provided, the liquid transporting method comprising:
performing choke suction of charging the pump with the liquid, and performing a suction operation of sucking the inner portion of the nozzle by using the suction unit, and then, performing a transmission operation of pressing the liquid from the pump towards the output valve.

2. The liquid transporting method according to claim 1, wherein the choke suction is performed several times.

3. The liquid transporting method according to claim 2, wherein, normal suction of performing only the suction operation is performed after the choke suction is performed several times.

4. The liquid transporting method according to claim 1, wherein, the diaphragm pump is charged with the liquid after the transmission operation.

5. A method of cleaning a liquid ejecting apparatus having a fluid ejecting head with a nozzle, a liquid storing unit connected through a flow passage to the fluid ejecting head, a suction unit sucking an inner portion of the nozzle from a nozzle opening side, a pump driven to change an internal volume of a pump chamber that is a portion of the flow passage, and an output valve opened only at the time when the output valve is pressed from the pump, comprising:
performing a suction operation of sucking the inner portion of the nozzle by using the suction unit, and then, performing a transmission operation of pressing the liquid from the pump to the output valve.

6. A method of cleaning a liquid ejecting apparatus having a fluid ejecting head with a nozzle, a liquid storing unit connected through a flow passage to the fluid ejecting head, a suction unit sucking an inner portion of the nozzle from a nozzle opening side, a pump driven to change an internal volume of a pump chamber that is a portion of the flow passage, and an output valve opened only at the time when the output valve is pressed from the pump, comprising:
charging the pump with the liquid; and
performing a suction operation of sucking the inner portion of the nozzle by using the suction unit, and then, selecting one of a choke cleaning operation where a transmission operation of pressing the liquid from the pump towards the output valve is performed and a normal cleaning operation where only the suction operation is performed,
wherein, in the case where the choke cleaning operation is selected, the choke cleaning operation and the normal cleaning operation are consecutively performed, and
wherein, in the case where the normal cleaning operation is selected, only the normal cleaning operation is performed.
